(19) United States
(12) Patent Application Publication
(10) Pub. No.: US 2026/0309306 A1
(43) Pub. Date: Oct. 8, 2026

(54) EDGE-LIT LIGHT FIXTURE WITHOUT A WAVEGUIDE

(71) Applicant: SIGNIFY HOLDING B.V., EINDHOVEN (NL)

(72) Inventors: PHILIP DEAN WINTERS, CENTRE, AL (US); WILSTON NIGEL CHRISTOPHER SAYERS, PEACHTREE CITY, GA (US)

(21) Appl. No.: 19/482,398

(22) PCT Filed: Apr. 22, 2024
(86) PCT No.: PCT/EP2024/060938

§ 371 Date: Nov. 7, 2025

Related U.S. Application Data
(60) Provisional application No. 63/464,980, filed on May 9, 2023.

(30) Foreign Application Priority Data
Jun. 2, 2023 (EP) 23176896.1

(51) Int. Cl. F21V 7/00; F21V 7/06; F21V 17/06; F21Y 107/10; F21Y 115/10

(52) U.S. Cl. CPC F21V 7/0008; F21V 7/0041; F21V 7/06; F21V 17/06; F21Y 2107/10; F21Y 2115/10

(57) ABSTRACT

An edge-light light fixture (100) can include a housing (140) having a side wall (141) and a top wall (142) that form a cavity (145). The light fixture can also include a circuit board assembly (120) disposed on the side wall (141) of the housing. The light fixture can also include an optical device (130) coupled to a distal end of the side wall (141) of the housing, where the optical device (130) closes off the open bottom end of the cavity. The light fixture can also include a reflector (110) disposed in the cavity, where the reflector (110) has a convex curvature (115) along a height (114) between a top end (117) and a bottom end (116), where the bottom end (116) of the reflector (110) is positioned proximate to a junction of the optical device (130) and the distal end of the side wall (141), where the top end (117) of the reflector is positioned in the cavity (145) at a horizontal distance (192) away from the circuit board (121).

### TECHNICAL FIELD

The present disclosure relates generally to lighting systems, and more particularly to systems, methods, and devices for edge-lit light fixtures without waveguides.

### BACKGROUND

Edge-lit light fixtures (types of luminaires that are part of lighting systems) use a waveguide (also sometimes called a lightguide) to direct light emitted by the light sources into a volume of space to provide general illumination. The waveguide is an expensive component because of its thin profile (e.g., 3 mm, 5 mm) and because of all of the optical properties (e.g., reflectors and refractive qualities) that are incorporated to receive light from its side and redirect the light downward in a substantially uniform distribution pattern.

### SUMMARY

In general, in one aspect, the disclosure relates to an edge-lit light fixture that includes a housing having a side wall and a top wall that form a cavity having an open bottom end. The edge-lit light fixture can also include a circuit board assembly disposed on the side wall of the housing, where the circuit board includes a circuit board and a light source coupled to the circuit board, where the light source is oriented on the circuit board to direct light into the cavity. The edge-lit light fixture can further include an optical device coupled to a distal end of the side wall of the housing, where the optical device closes off the open bottom end of the cavity. The edge-lit light fixture can also include a reflector disposed in the cavity, wherein the reflector has a convex curvature along a height between a top end and a bottom end, where the bottom end of the reflector is positioned proximate to a junction of the optical device and the distal end of the side wall, where the top end of the reflector is positioned in the cavity at a horizontal distance away from the circuit board.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIGS. 1A through 1E show various views of an edge-lit light fixture without a waveguide according to certain example embodiments.

FIG. 2 shows a bottom view of a subassembly of the edge-lit light fixture without a waveguide of FIGS. 1A through 1E according to certain example embodiments.

FIGS. 3A and 3B show various views of a reflector of the edge-lit light fixture without a waveguide of FIGS. 1A through 1E according to certain example embodiments.

FIGS. 4A and 4B show various views of the housing of the edge-lit light fixture without a waveguide of FIGS. 1A through 1E according to certain example embodiments.

FIG. 5 shows a sectional side view of a portion of another housing of an edge-lit light fixture without a waveguide according to certain example embodiments.

FIG. 6 shows a sectional side view of a portion of yet another housing of an edge-lit light fixture without a waveguide according to certain example embodiments.

FIG. 7 shows a sectional side view of a portion of another reflector of an edge-lit light fixture without a waveguide according to certain example embodiments.

FIG. 8 shows a sectional side view of a portion of yet another reflector of an edge-lit light fixture without a waveguide according to certain example embodiments.

FIG. 9 shows a sectional side view of another optical device of an edge-lit light fixture without a waveguide according to certain example embodiments.

FIG. 10 shows a sectional side view of a portion of another edge-lit light fixture without a waveguide according to certain example embodiments.

FIG. 11 shows a sectional side view of a portion of yet another edge-lit light fixture without a waveguide according to certain example embodiments.

FIGS. 12A and 12B show light distribution patterns for the edge-lit light fixture of FIGS. 1A through 1E according to certain example embodiments.

### DETAILED DESCRIPTION

In general, example embodiments provide systems, methods, and devices for edge-lit light fixtures without waveguides. Example embodiments can provide a number of benefits. Such benefits can include, but are not limited to, fewer parts to keep in inventory, reduced cost, modularity, ease of installation, increased configurability options, longevity of optical devices, less weight, reduced use of plastics, user control, and increased reliability. Example embodiments can be used with new edge-lit light fixtures or retrofit with existing edge-lit light fixtures. Example embodiments described herein can be used with edge-lit light fixtures having any of a number of shapes (e.g., circular, square, oval, rectangular, triangular) when viewed from above. Further, example embodiments described herein can be used with edge-lit light fixtures having any of a number of sizes (e.g., 2 inch diameter, 3 inch width, 4 inch major axis, one inch height, 6 inch diameter, 5 inches per side, 10 inch diameter).

Example edge-lit light fixtures without waveguides can be located in one or more of any of a number of environments. Examples of such environments can include, but are not limited to, indoors, outdoors, a parking garage, a kitchen or cooking space, a hallway, an entertainment room, an office space, a manufacturing plant, a warehouse, and a storage facility, any of which can be climate-controlled or non-climate-controlled. In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill.

Example edge-lit light fixtures without waveguides can be directly or indirectly mounted onto any of a number of different structures. Such structures can include, but are not limited to, the underside of a cabinet, drywall, wood studs, and ceiling tile. Indirect mounting of example edge-lit light fixtures without waveguides can involve the use of cables, standoffs, conduit, and spacers. A user may be any person that interacts with lighting systems. Examples of a user may include, but are not limited to, an engineer, an electrician, an instrumentation and controls technician, an operator, a property manager, a homeowner, a tenant, an employee, a consultant, a contractor, and a manufacturer's representative.

Example edge-lit light fixtures without waveguides (including portions thereof) can be made of one or more of a number of suitable materials to allow the edge-lit light fixtures (or portions thereof) to meet certain standards and/or regulations while also maintaining durability in light of the one or more conditions under which the edge-lit light fixtures and/or other associated components of the edge-lit light fixtures can be exposed. Examples of such materials can include, but are not limited to, silicone, aluminum, stainless steel, fiberglass, glass, plastic, polymer, ceramic, and rubber.

Example edge-lit light fixtures without waveguides, or portions thereof, described herein can be made from a single piece (as from a mold, injection mold, die cast, 3D printing process, and/or extrusion process). In addition, or in the alternative, example edge-lit light fixtures without waveguides (including portions thereof) can be made from multiple pieces that are mechanically coupled to each other. In such a case, the multiple pieces can be mechanically coupled to each other using one or more of a number of coupling methods, including but not limited to epoxy, welding (e.g., sonic welding, soldering), crimping, heat staking, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more portions of an example edge-lit light fixture without a waveguide to become coupled, directly or indirectly, to one or more other components of the edge-lit light fixture without a waveguide and/or to a structure (e.g., a bottom of a cabinet). A coupling feature can include, but is not limited to, a clamp, a portion of a hinge, an aperture, a recessed area, a protrusion, a hole, a slot, a tab, a detent, and mating threads. One portion of an example edge-lit light fixture without a waveguide can be coupled to a component of the edge-lit light fixture without a waveguide and/or to a structure by the direct use of one or more coupling features.

In addition, or in the alternative, a portion of an example edge-lit light fixture without a waveguide can be coupled to another component of the edge-lit light fixture without a waveguide and/or to a structure using one or more independent devices that interact with one or more coupling features disposed on the edge-lit light fixture without a waveguide. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

In the foregoing figures showing example embodiments of edge-lit light fixtures without waveguides, one or more of the components shown may be omitted, repeated, and/or substituted. Accordingly, example embodiments of edge-lit light fixtures without waveguides should not be considered limited to the specific arrangements of components shown in any of the figures. For example, features shown in one or more figures or described with respect to one embodiment can be applied to another embodiment associated with a different figure or description.

In certain example embodiments, lighting systems that include example edge-lit light fixtures without waveguides are subject to meeting certain standards and/or requirements. For example, the National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) set standards as to electrical enclosures, wiring, and electrical connections. Use of example embodiments described herein meet (and/or allow the lighting systems to meet) such standards when applicable.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number or a four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of edge-lit light fixtures without waveguides will be described more fully hereinafter with reference to the accompanying drawings, in which example embodiments of edge-lit light fixtures without waveguides are shown. Edge-lit light fixtures without waveguides may, however, be embodied in many different forms and should not be construed as limited to the example embodiments set forth herein. Rather, these example embodiments are provided so that this disclosure will be thorough and complete, and will fully convey the scope of edge-lit light fixtures without waveguides to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of edge-lit light fixtures without waveguides. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

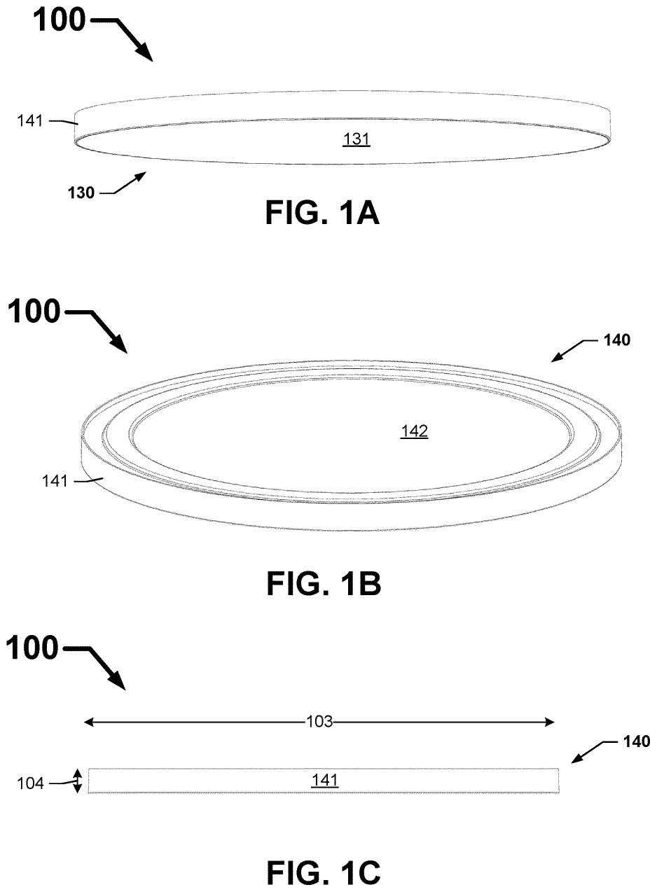

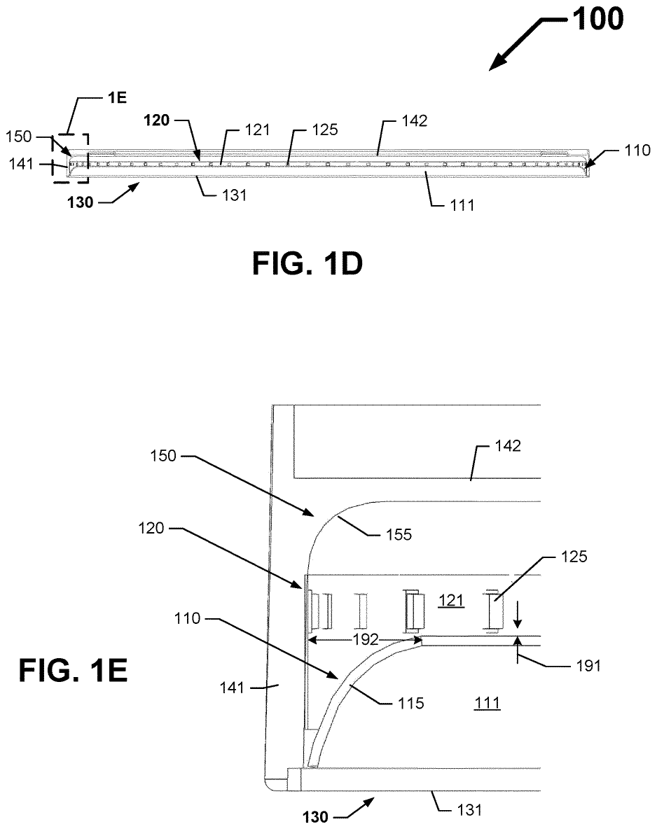

FIGS. 1A through 1E show various views of an edge-lit light fixture 100 without a waveguide according to certain example embodiments. Specifically, FIG. 1A shows a bottom perspective view of the edge-lit light fixture 100. FIG. 1B shows a top perspective view of the edge-lit light fixture 100. FIG. 1C shows a side view of the edge-lit light fixture 100. FIG. 1D shows a sectional side view of the edge-lit light fixture 100. FIG. 1E shows a detailed sectional side view of the edge-lit light fixture 100.

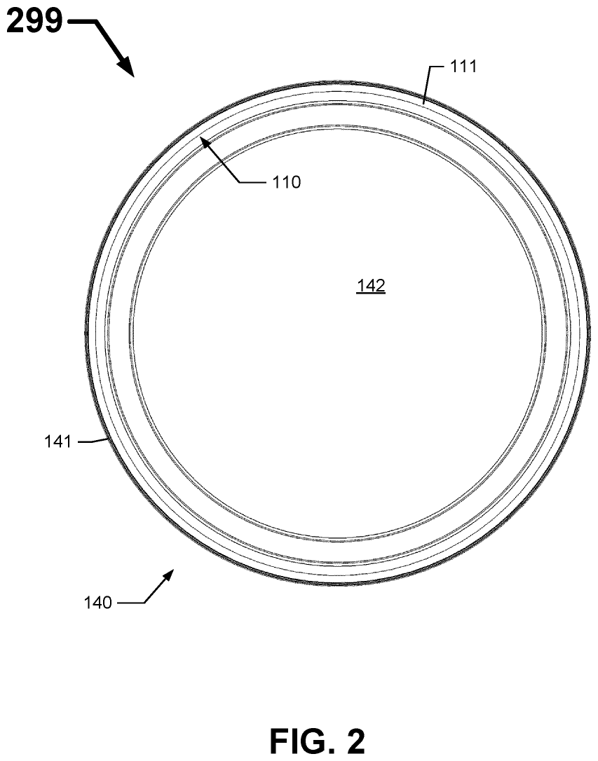

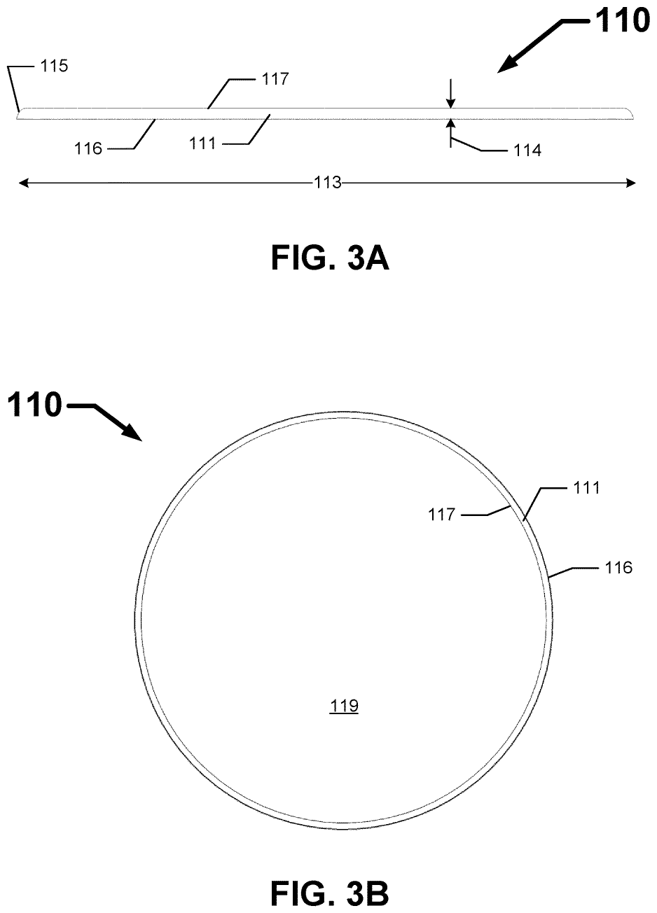

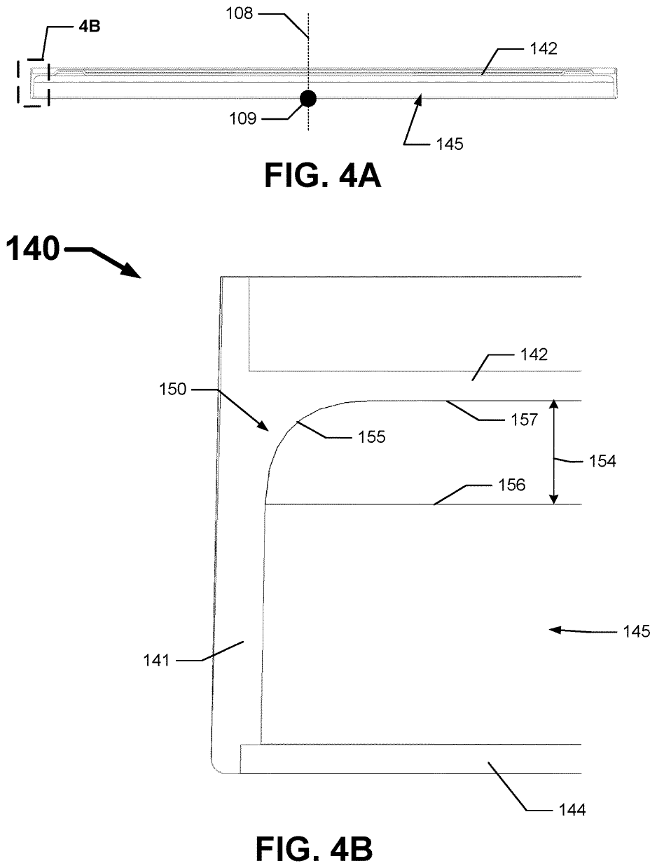

FIG. 2 shows a bottom view of a subassembly 299 of the edge-lit light fixture 100 without a waveguide of FIGS. 1A through 1E according to certain example embodiments. FIGS. 3A and 3B show a side view and a bottom view, respectively, of a reflector 110 of the edge-lit light fixture 100 without a waveguide of FIGS. 1A through 1E according to certain example embodiments. FIGS. 4A and 4B show sectional side views of the housing 140 of the edge-lit light fixture 100 without a waveguide of FIGS. 1A through 1E according to certain example embodiments.

Referring to FIGS. 1A through 4B, the edge-lit light fixture 100 has no waveguide. To compensate for the lack of a waveguide, the edge-lit light fixture 100 can include one or more components and/or features, as discussed below. The edge-lit light fixture 100 shown in FIGS. 1A through 1E includes a circuit board assembly 120, a housing 140, a reflector 110, and an optical device 130. The circuit board assembly 120 includes a circuit board 121 and one or more light sources 125 coupled to the circuit board 121. The edge-lit light fixture 100 can include one or more of any of a number of other components (e.g., a power source) that are not shown in FIGS. 1A through 1E.

The housing 140 of the edge-lit light fixture 100, an example of which is shown in isolation in FIGS. 4A and 4B, can have any of a number of shapes and/or features. For example, in this case, the housing 140 is generally cylindrical (i.e., having a circular shape when viewed from below), having a top wall 142 and at least one side wall 141 that form a cavity 145 with an open bottom end. The housing 140 can be made of a thermally-conductive material (e.g., metal, thermoplastic) that allows the housing 140 to act as a heat sink, absorbing heat generated within the cavity 145 (e.g., by the one or more light sources 125) and subsequently dissipating the heat into the ambient environment outside the cavity 145.

When the housing 140 has a different shape (e.g., square, octagonal) when viewed from below, the housing 140 can have multiple side walls 141 rather than a single curved side wall 141, as in this case. Some or all of the inner surface of the side wall 141 and/or some or all of the inner surface of the top wall 142 can be or be coated with a reflective (e.g., highly reflective) material (e.g., coated with a glossy acrylic, made of a highly polished light-colored metal). In addition, or in the alternative, some or all of the inner surface of the side wall 141 and/or some or all of the inner surface of the top wall 142 can be of a color (e.g., bright white) that is reflective (e.g., highly reflective). The housing 140 has a height 104 (e.g., 5 mm, 10 mm, 1 inch) and a width 103 (e.g., 1 inch, 2 inches, 4 inches, 6 inches, 12 inches). In this case, since the housing 140 is cylindrical, the width 103 is also the diameter. The housing 140 (or portions thereof) can be made from one or more of any of a number of manufacturing methods, including but not limited to extrusion, 3D printing, and injection molding.

The inner surface of the side wall 141 and/or the top wall 142 can have one or more coupling features (e.g., slots, recesses, protrusions) disposed therein to allow for the coupling of another component (e.g., the circuit board 121, an example reflector 110, the optical device 130) within the cavity 145. For example, as shown in FIG. 4B, there is a recess 144 disposed in the inner surface of the side wall 141 at its distal end (i.e., the bottom) along the entire perimeter of the side wall 141. Other examples of such coupling features disposed in the side wall 141 and/or the top wall 142 of the housing 140 are discussed below. The outer surface of the top wall 142 of the housing 140 can include one or more coupling features (e.g., slots, recesses, tabs, channels) that can be used to allow the housing 140 to be directly or indirectly coupled to a structure (e.g., the underside of a cabinet, a mounting structure).

In certain example embodiments, an example reflector 150 can be integrated into the inner surfaces of the side wall 141 and/or the top wall 142 of the housing 140. In this case, the reflector 150 is a curved transition between the proximal end (i.e., the top) of the side wall 141 and the outer perimeter of the top wall 142 along their inner surfaces. Some or all of the reflector 150 can be or be coated with a reflective (e.g., a highly reflective) material, which can be the same or different than the reflective material of the inner surfaces of the side wall 141 and/or the top wall 142 of the housing 140. In addition, or in the alternative, some or all of the reflector 150 can be of a color that is reflective.

In alternative embodiments, rather than being integrated with the housing 140, the reflector 150 can be a separate component that is coupled to the housing 140 toward the top of the cavity 145. When the reflector 150 exists, the reflector 150 can have a curvature 155 between a top end 157 and the bottom end 156 of the reflector 150. The curvature 155 can be concave (as in this example), convex, or zero (i.e., the reflector 150 is planar). The curvature 155 of the reflector 150 can be radial, parabolic, elliptical, or have some other definition of the curvature. In this case, the curvature 155 of the reflector 150 is parabolic with the focus substantially coinciding with the center of the optical device 130, which also coincides with the center 109 of the bottom of the housing 140. Alternatively, the focus of the curvature 155 of the reflector 150 can be at some point along a vertical axis 108 that passes through the center 109 of the bottom of the housing 140. The reflector 150 also has a height 154 (e.g., a true vertical height) that spans between the top end 157 and the bottom end 156 of the reflector 150.

In certain example embodiments, the reflector 150 forms a closed shape. In other words, the reflector 150 can be continuous along its length. The bottom end 156 of the reflector 150 can have a shape and size that corresponds to a perimeter formed by the part of the inner surface of the side wall 141 of the housing 140 to which the bottom end 156 is coupled. The reflector 150 can have an outer surface (i.e., facing the adjacent side wall 141 and top wall 142 of the housing 140) and an inner surface opposite the outer surface. The reflector 150 can be an optional feature of the housing 140 and/or an optional component of the edge-lit light fixture 100.

The circuit board assembly 120 of the edge-lit light fixture 100 is disposed on (e.g., coupled to) the side wall 141 of the housing 140. There can be any of a number of light sources 125 coupled to the circuit board 121 of the circuit board assembly 120. In some cases, as in this example, the circuit board 121 can be flexible so that the shape of the circuit board 121 (or portions thereof) can have and maintain a three-dimensional shape. In such cases, the circuit board 121 (or portions thereof) can be made of an elastic or flexible material. In this way, the circuit board 121 can be inserted into the cavity 145 of the housing 140 and conform to the inner perimeter of the side wall 141 of the housing 140. When the circuit board 121 is flexible, the circuit board 121 can maintain its altered shape or revert back to its default shape when the forces used to alter the shape of the circuit board 121 are no longer applied. Alternatively, the circuit board 121 can be rigid or mostly rigid, in which case the circuit board 121 can be shaped during manufacturing to conform with the shape and size of the inner perimeter of the side wall 141 of the housing 140.

The circuit board 121 can be coupled to the side wall 141 of the housing 140 in any of a number of ways using any of a number of coupling features. For example, the side wall 141 of the housing 140 can include one or more coupling features (e.g., recesses, clips, tabs, threaded apertures) to allow the circuit board 121 to directly or indirectly couple to the side wall 141 of the housing 140. As another example, epoxy can be used to affix the circuit board 121 to the side wall 141 of the housing 140.

As discussed above, one or more light sources 125 can be coupled to the circuit board 121. Each of the light sources 125 can oriented on the circuit board 121 in such a way as to direct light emitted by the light source 125 into the cavity 145 of the housing 140. Each light source 125 can use any type of lighting technology. Examples of such lighting technology can include, but are not limited to, light emitting diodes (LEDs), plasma, bioluminescence, and organic LEDs (OLEDs). When the circuit board assembly 120 includes multiple light sources 125, the spacing between two adjacent light sources 125 can be the same as, or different than, the spacing between two other adjacent light sources 125 of the circuit board assembly 120. Also, when the circuit board assembly 120, the light sources 125 can be arranged in any of a number of ways on the circuit board 121. For example, all of the light sources 125 can be arranged in a single row along the middle of the circuit board 121 along the length of the circuit board 121. As another example, the light sources 125 can be arranged in two parallel rows along the length of the circuit board 121, where the light sources 125 in each row are spaced equidistantly from each other.

The optical device 130 of the edge-lit light fixture 100 has a body 131 and can be removably coupled to a distal end (i.e., bottom) of the side wall 141 of the housing 140. When the optical device 130 is coupled to the housing 140, the optical device 130 closes off the open bottom end of the cavity 145 formed by the housing 140. The optical device 130 can include one or more features and/or components. For example, the optical device 130 can have a coupling feature (e.g., mating threads, a protruding portion, tabs, apertures) that complements corresponding coupling features of the housing 140 to allow the optical device 130 to directly or indirectly couple to the housing 140. The optical device 130 can also include one or more optical features (e.g., reflectors, refractors) disposed in the body that are configured to manipulate the light emitted by the light sources 125 as the light travels from the cavity 145 to a volume of space outside the cavity 145 to provide general illumination or illumination for some other purpose for which the optical device 130 is designed to provide. The optical device 130 can have a shape and size that prevents light from leaking between the optical device 130 and the side wall 141 of the housing 140.

The example reflector 110 of the edge-lit light fixture 100 is disposed in the cavity 145 formed by the housing 140 and the optical device 130. The reflector 110 can be configured to serve one or more purposes. For example, the reflector 110 can be configured to hide the light sources 125 from view by a user positioned below the edge-lit light fixture 100. Some or all of the reflector 110 can lack a vertical and/or a horizontal orientation along its true vertical height 114. For example, the reflector 110 can have a body 111 with a convex curvature 115 along its true vertical height 114 between its top end 117 and its bottom end 116. The various characteristics (e.g., curvature 115, true vertical height 114, material, color) of the reflector 110 can be the same as, or different than, the corresponding characteristics of the reflector 150, to the extent that the edge-lit light fixture 100 includes the reflector 150.

In certain example embodiments, the example reflector 110 is positioned toward the bottom of the cavity 145. For example, the bottom end 116 of the reflector 110 can be positioned proximate to a junction of the optical device 130 and the distal (bottom) end of the side wall 141 of the housing 140. In such a case, the top end 117 of the reflector 110 can be positioned in the cavity 145 at a horizontal distance 192 away from the circuit board 121, as shown in FIG. 1E. In addition, or in the alternative, the top end 117 of the reflector 110 can be positioned in the cavity 145 at a vertical distance 191 below the bottom end of the light sources 125, as shown in FIG. 1E.

The curvature 115 of the reflector 110 is between the top end 117 and the bottom end 116 of the reflector 110. The curvature 115 can be concave (as in this example), convex, or zero (i.e., the reflector 110 is planar). The curvature 115 of the reflector 110 can be radial, parabolic, elliptical, or have some other definition of the curvature. In this case, the curvature 115 of the reflector 110 is parabolic with the focus substantially coinciding with the center of the optical device 130, which also coincides with the center 109 of the bottom of the housing 140. Alternatively, the focus of the curvature 115 of the reflector 110 can be some other point along a vertical axis 108 that passes through the center 109 of the bottom of the housing 140. The reflector 110 also has a height 114 (e.g., a true vertical height) that spans between the top end 117 and the bottom end 116 of the reflector 110.

In certain example embodiments, the reflector 110 forms a closed shape. In other words, the reflector 110 can be continuous along its length. The bottom end 116 of the reflector 110 can have a shape and size that corresponds to a perimeter formed by the part of the inner surface of the side wall 141 of the housing 140 to which the bottom end 116 of the reflector 110 is coupled. The reflector 110 can have an outer surface (i.e., facing the adjacent side wall 141 of the housing 140) and an inner surface (i.e., facing the optical device 130) opposite the outer surface. In some cases, the inner surface and/or the outer surface of the reflector 110 can be of a color and/or have a material that is reflective.

The reflector 110 and its various characteristics (e.g., curvature 115, color, coating, true vertical height 114), as well as the characteristics (e.g., color, coating) of the inner surfaces of the side wall 141 and the top wall 142 of the housing 140, as well as the characteristics (e.g., curvature 155, color, coating, true vertical height 154) of the optional reflector 150, can redirect light through an optical device at the bottom end of the housing 140 that is substantially evenly distributed without hot spots or dead spots. In this way, the edge-lit light fixture 100 can function without a waveguide or lightguide. Further, the reflector 110 prevents a user from looking into the cavity 145 through the optical device 130 from seeing any of the light sources 125. In alternative embodiments, rather than being a separate component, the reflector 110 can be integrated with the housing 140.

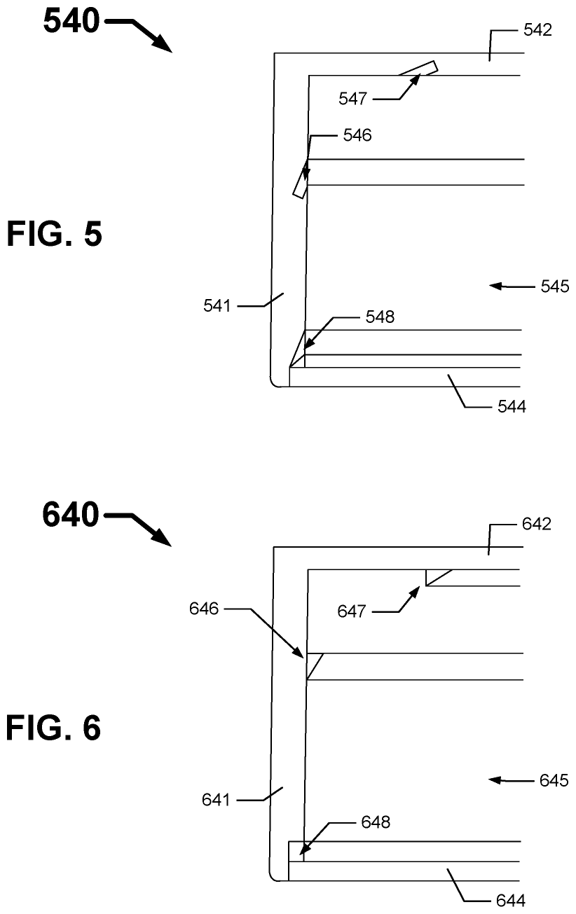

FIG. 5 shows a sectional side view of a portion of another housing 540 of an edge-lit light fixture without a waveguide according to certain example embodiments. Referring to FIGS. 1A through 5, the housing 540 of FIG. 5 is substantially the same as the housing 140 discussed above, except as described below. For example, the housing 540 of FIG. 5 is generally cylindrical (i.e., having a circular shape when viewed from below), having a top wall 542 and a side wall 541 that form a cavity 545 with an open bottom end. The housing 540 can be made of a thermally-conductive material (e.g., metal, thermoplastic) that allows the housing 540 to act as a heat sink.

Some or all of the inner surface of the side wall 541 and/or some or all of the inner surface of the top wall 542 can be or be coated with a reflective (e.g., highly reflective) material (e.g., coated with a glossy acrylic, made of a highly polished light-colored metal). In addition, or in the alternative, some or all of the inner surface of the side wall 541 and/or some or all of the inner surface of the top wall 542 can be of a color (e.g., bright white) that is reflective (e.g., highly reflective).

The inner surface of the side wall 541 and/or the top wall 542 of the housing 540 can have one or more coupling features (e.g., slots, recesses, protrusions) disposed therein to allow for the coupling of another component (e.g., the circuit board 121, an example reflector 110, the optical device 130) within the cavity 545. For example, in this case, there is a coupling feature 544 (similar to the recess 144 discussed above) in the form of a recess disposed in the inner surface of the side wall 541 at its distal end (i.e., the bottom) along the entire perimeter of the side wall 541. The coupling feature 544 is configured to receive and couple to the optical device (e.g., optical device 130).

As another example, there is a coupling feature 548 in the form of a wedge-shaped recess disposed in the inner surface of the side wall 541 toward its distal end (i.e., the bottom), just above the coupling feature 544, along the entire perimeter of the side wall 541. The coupling feature 548 is configured to receive and couple to the bottom end (e.g., bottom end 116) of a reflector (e.g., reflector 110) when the bottom end of the reflector is tapered, having a shape and size the complements the shape and size of the coupling feature 548.

As yet another example, there is a coupling feature 546 in the form of a recess disposed in the inner surface of the side wall 541 toward its proximal end (i.e., the top), just above where the circuit board (e.g., circuit board 121) of the circuit board assembly (e.g., circuit board assembly 120) is configured to be positioned, along the entire perimeter of the side wall 541. The coupling feature 546 is configured to receive and couple to the bottom end (e.g., bottom end 156) of a reflector (e.g., reflector 150) when the bottom end of the reflector is squared and where the reflector is a separate component rather than an integrated part of the housing 540.

As still another example, there is a coupling feature 547 in the form of a recess disposed in the inner surface of the top wall 542 toward where the top wall 542 meets the side wall 541 in a full circle. The coupling feature 547 is configured to receive and couple to the top end (e.g., top end 157) of a reflector (e.g., reflector 150) when the top end of the reflector is squared and where the reflector is a separate component rather than an integrated part of the housing 540. In this way, an example reflector (e.g., reflector 150), as an independent component, can be coupled to the inner surfaces of the side wall 541 and the top wall 542 of the housing 540.

FIG. 6 shows a sectional side view of a portion of yet another housing 640 of an edge-lit light fixture without a waveguide according to certain example embodiments. Referring to FIGS. 1A through 6, the housing 640 of FIG. 6 is substantially the same as the housings discussed above, except as described below. For example, the housing 640 of FIG. 6 is generally cylindrical (i.e., having a circular shape when viewed from below), having a top wall 642 and a side wall 641 that form a cavity 645 with an open bottom end. The housing 640 can be made of a thermally-conductive material (e.g., metal, thermoplastic) that allows the housing 540 to act as a heat sink.

Some or all of the inner surface of the side wall 641 and/or some or all of the inner surface of the top wall 642 can be or be coated with a reflective (e.g., highly reflective) material (e.g., coated with a glossy acrylic, made of a highly polished light-colored metal). In addition, or in the alternative, some or all of the inner surface of the side wall 641 and/or some or all of the inner surface of the top wall 642 can be of a color (e.g., bright white) that is reflective (e.g., highly reflective).

The inner surface of the side wall 641 and/or the top wall 642 of the housing 640 can have one or more coupling features (e.g., slots, recesses, protrusions) disposed therein to allow for the coupling of another component (e.g., the circuit board 121, an example reflector 110, the optical device 130) within the cavity 645. For example, in this case, there is a coupling feature 644 (similar to the recess 144 discussed above) in the form of a recess disposed in the inner surface of the side wall 641 at its distal end (i.e., the bottom) along the entire perimeter of the side wall 641. The coupling feature 644 is configured to receive and couple to the optical device (e.g., optical device 130).

As another example, there is a coupling feature 648 in the form of a recess disposed in the inner surface of the side wall 641 toward its distal end (i.e., the bottom), just above the coupling feature 644, along the entire perimeter of the side wall 641. The coupling feature 648 is configured to receive and couple to the bottom end (e.g., bottom end 116) of a reflector (e.g., reflector 110) when the bottom end of the reflector includes a lateral extension having a shape and size the complements the shape and size of the coupling feature 648.

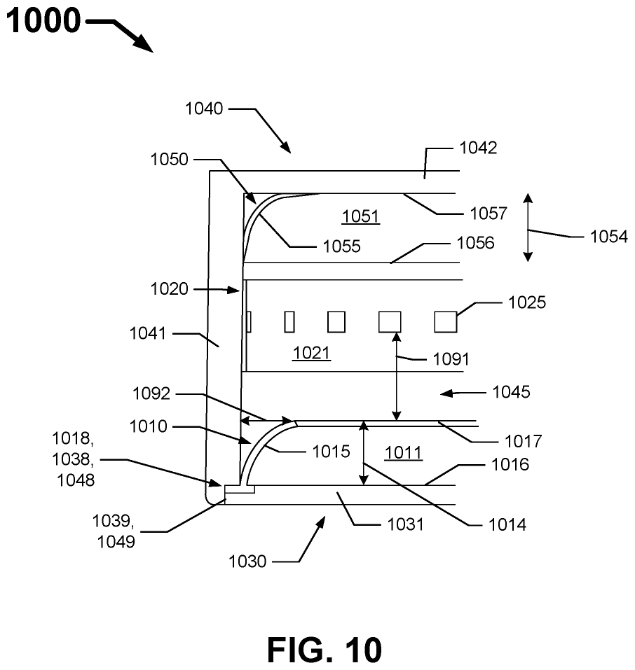

As yet another example, there is a coupling feature 646 in the form of a protrusion that extends from the inner surface of the side wall 641 toward its proximal end (i.e., the top), just above where the circuit board (e.g., circuit board 121) of the circuit board assembly (e.g., circuit board assembly 120) is configured to be positioned, along the entire perimeter of the side wall 641. The coupling feature 646 is configured to receive and couple to (abut against) the bottom end (e.g., bottom end 1056 in FIG. 10 below) of a reflector (e.g., reflector 1050 in FIG. 10 below) when the bottom end of the reflector is squared and where the reflector is a separate component rather than an integrated part of the housing 640.

As still another example, there is a coupling feature 647 in the form of a protrusion that extends from the inner surface of the top wall 642 toward where the top wall 642 meets the side wall 641 in a full circle. The coupling feature 647 is configured to receive and couple to (abut against) the top end (e.g., top end 1057 in FIG. 10 below) of a reflector (e.g., reflector 1050 in FIG. 10 below) when the top end of the reflector is squared and where the reflector is a separate component rather than an integrated part of the housing 640. In this way, an example reflector (e.g., reflector 1050 in FIG. 10 below), as an independent component, can be coupled to the inner surfaces of the side wall 641 and the top wall 642 of the housing 640.

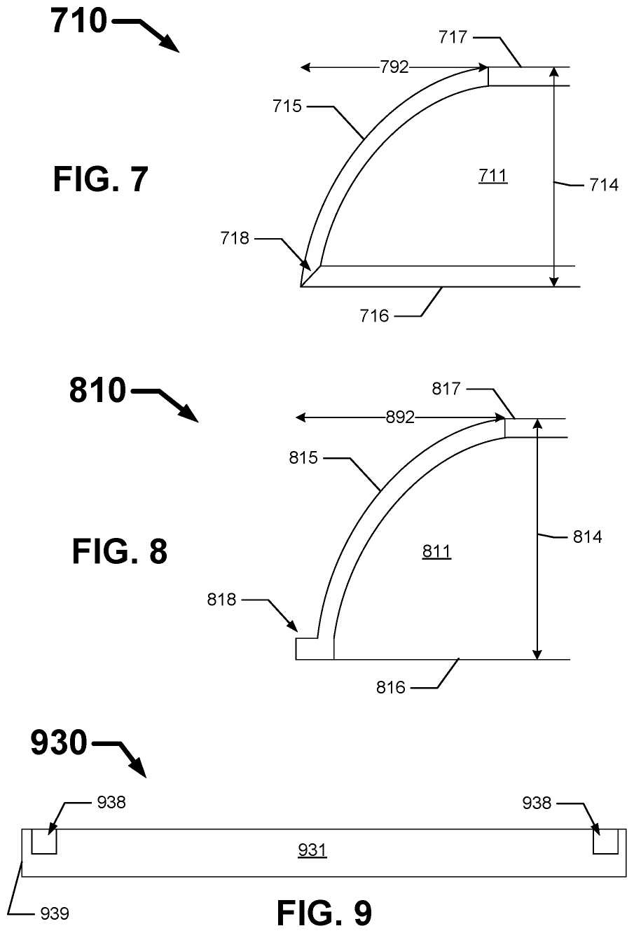

FIG. 7 shows a sectional side view of a portion of another reflector 710 of an edge-lit light fixture without a waveguide according to certain example embodiments. Referring to FIGS. 1A through 7, the reflector 710 of FIG. 7 is substantially the same as the reflector 110 discussed above, except as described below. For example, the reflector 710 is configured to be disposed in a cavity (e.g., the cavity 545) formed by a housing (e.g., housing 540) and an optical device (e.g., optical device 130). The reflector 710 has a body 711 with a convex curvature 715 along its true vertical height 714 between its top end 717 and its bottom end 716. The various characteristics (e.g., curvature 715, true vertical height 714, material, color) of the reflector 710 can be the same as, or different than, the corresponding characteristics another reflector (e.g., reflector 150) of an edge-lit light fixture (e.g., edge-lit light fixture 100).

The example reflector 710 can be configured to be positioned within the cavity 545 of the housing 540 of FIG. 5. For example, the bottom end 716 of the reflector 710 can include a wedge-shaped protrusion 718 that complements the coupling feature 548 in the form of the wedge-shaped recess in the side wall 541 of the housing 540 in FIG. 5. In this way, when the wedge-shaped protrusion 718 is inserted into the coupling feature 548 in the form of the wedge-shaped recess, the reflector 710 becomes positioned within the cavity 545 similar to how the reflector 110 is positioned in the cavity 145 in FIG. 1E. In such a case, the top end 717 of the reflector 710 can be positioned in the cavity 545 at a horizontal distance 792 away from the side wall 541 and/or a circuit board (e.g., circuit board 121), similar to what is shown in FIG. 1E. In addition, the top end 717 of the reflector 710 can be positioned in the cavity 545 at a vertical distance (e.g., vertical distance 191) below the bottom end of the light sources (e.g., light sources 125), similar to what is shown in FIG. 1E.

The curvature 715 of the body 711 of the reflector 710 is between the top end 717 and the bottom end 716 of the reflector 710. The curvature 715 of the reflector 710 in this case is parabolic. The reflector 710 forms a closed shape. In other words, the reflector 710 is continuous along its length. The reflector 710 has an outer surface (e.g., facing the adjacent side wall 541 of the housing 540) and an inner surface opposite the outer surface.

The inner surface and/or the outer surface of the reflector 710 can be of a color and/or have a material that is reflective.

FIG. 8 shows a sectional side view of a portion of yet another reflector 810 of an edge-lit light fixture without a waveguide according to certain example embodiments. Referring to FIGS. 1A through 8, the reflector 810 of FIG. 8 is substantially the same as the reflectors discussed above, except as described below. For example, the reflector 810 is configured to be disposed in a cavity (e.g., the cavity 645) formed by a housing (e.g., housing 640) and an optical device (e.g., optical device 130). The reflector 810 has a body 811 with a convex curvature 815 along its true vertical height 814 between its top end 817 and its bottom end 816. The various characteristics (e.g., curvature 815, true vertical height 814, material, color) of the reflector 810 can be the same as, or different than, the corresponding characteristics another reflector (e.g., reflector 150) of an edge-lit light fixture (e.g., edge-lit light fixture 100).

The example reflector 810 can be configured to be positioned within the cavity 645 of the housing 640 of FIG. 6. For example, the bottom end 816 of the reflector 810 can include a lateral protrusion 818 that complements the lateral recess 648 in the side wall 641 of the housing 640 in FIG. 6. In this way, when the lateral protrusion 818 is inserted into the lateral recess 648, the reflector 810 becomes positioned within the cavity 645 similar to how the reflector 110 is positioned in the cavity 145 in FIG. 1E. In such a case, the top end 817 of the reflector 810 can be positioned in the cavity 645 at a horizontal distance 892 away from the side wall 641 and/or a circuit board (e.g., circuit board 121), similar to what is shown in FIG. 1E. In addition, the top end 817 of the reflector 810 can be positioned in the cavity 645 at a vertical distance (e.g., vertical distance 191) below the bottom end of the light sources (e.g., light sources 125), similar to what is shown in FIG. 1E.

The curvature 815 of the body 811 of the reflector 810 is between the top end 817 and the bottom end 816 of the reflector 810. The curvature 815 of the reflector 810 in this case is parabolic. The reflector 810 forms a closed shape. In other words, the reflector 810 is continuous along its length. The reflector 810 has an outer surface (e.g., facing the adjacent side wall 641 of the housing 640) and an inner surface opposite the outer surface.

The inner surface and/or the outer surface of the reflector 810 can be of a color and/or have a material that is reflective.

FIG. 9 shows a sectional side view of another optical device 930 of an edge-lit light fixture without a waveguide according to certain example embodiments. Referring to FIGS. 1A through 9, the optical device 930 of FIG. 9 is substantially the same as the optical device 130 discussed above, except as described below. For example, the body 931 of the optical device 930 can be include coupling features 939 in the form of mating threads disposed along its outer perimeter to allow the optical device 930 to be directly removably coupled to complementary coupling features (also in the form of mating threads) disposed along the inner perimeter at the bottom of the side wall (e.g., side wall 141) of a housing (e.g., housing 140). When the optical device 930 is coupled to a housing, the optical device 930 closes off the open bottom end of the cavity (e.g., cavity 145) formed by the housing.

The body 931 of the optical device 930 includes a coupling feature 938 in the form of a channel or recess that forms a circle in the top surface of the optical device 930 toward the outer perimeter of the optical device 930 (which is also adjacent to the coupling feature 939). The coupling feature 938 allows the optical device 930 to directly couple to a reflector (e.g., reflector 110). The optical device 930 can also include one or more optical features (e.g., reflectors, refractors) to manipulate the light emitted by light sources (e.g., light sources 125) as the light travels from the cavity (e.g., cavity 145) to a volume of space outside the cavity to provide general illumination. The coupling feature 938 of the optical device 930 prevents light from leaking between the optical device 930 and the side wall of the housing.

FIG. 10 shows a sectional side view of a portion of another edge-lit light fixture 1000 without a waveguide according to certain example embodiments. Referring to FIGS. 1A through 10, the edge-lit light fixture 1000 (including components and/or features thereof) of FIG. 10 is substantially the same as the edge-lit light fixture 100 (including any corresponding components and/or features) discussed above with respect to FIGS. 1A through 9, except as described below. For example, the edge-lit light fixture 1000 of FIG. 10 includes a housing 1040, an optical device 1030, a circuit board assembly 1020, an example reflector 1010, and another example reflector 1050.

The circuit board assembly 1020 includes a circuit board 1021 and multiple light sources 1025 coupled to the circuit board 1021. The light sources 1025 are directed outward into the cavity 1045. The circuit board assembly 1020 of the edge-lit light fixture 1000 is disposed on (e.g., coupled to) the side wall 1041 of the housing 1040. The housing 1040 of the edge-lit light fixture 1000 is cylindrical, having a top wall 1042 and a side wall 1041 that form the cavity 1045 with an open bottom end. The housing 1040 is made of a thermally-conductive material that allows the housing 1040 to act as a heat sink.

Some or all of the inner surface of the side wall 1041 and/or some or all of the inner surface of the top wall 1042 can be or be coated with a reflective (e.g., highly reflective) material (e.g., coated with a glossy acrylic, made of a highly polished light-colored metal). In addition, or in the alternative, some or all of the inner surface of the side wall 1041 and/or some or all of the inner surface of the top wall 1042 can be of a color (e.g., bright white) that is reflective (e.g., highly reflective).

The inner surface of the side wall 1041 at the far bottom of the side wall 1041 includes a coupling feature 1049 in the form of mating threads. The coupling feature 1049 is used to couple the optical device 1030 to the housing 1040. The inner surface of the side wall 1041 also includes a coupling feature 1048 in the form of an inward recess toward the bottom of the side wall 1041. The coupling feature 1048 is located just above the coupling feature 1049. The coupling feature 1048 of the housing 1040 is used to couple to the reflector 1010, as discussed below. The coupling feature 1048 and the coupling feature 1049 are disposed along the entire perimeter of the side wall 1041.

The example reflector 1050 in this case is a separate component that is coupled (e.g., using epoxy, using sonic fusion, using an adhesive) to the housing 1040. Specifically, the top end 1057 of the reflector 1050 is coupled to the top wall 1042 of the housing 1040, and the bottom end 1056 of the reflector 1050 is coupled to the side wall 1041 of the housing 1040. The reflector 1050 can be or be coated with a reflective (e.g., a highly reflective) material, which can be the same or different than the reflective material of the inner surfaces of the side wall 1041 and/or the top wall 1042 of the housing 1040. In addition, some or all of the reflector 1050 can be of a color (e.g., bright white) that is reflective.

The body 1051 of the reflector 1050 has a curvature 1055 between the top end 1057 and the bottom end 1056 of the reflector 1050. The curvature 1055 is concave and radial (e.g., a circular arc). The reflector 1050 has a height 1054 (e.g., a true vertical height) that spans between the top end 1057 and the bottom end 1056 of the reflector 1050. The reflector 1050 forms a closed shape. In other words, the reflector 1050 is continuous along its length. The bottom end 1056 of the reflector 1050 can have a shape and size that corresponds to a perimeter formed by the part of the inner surface of the side wall 1041 of the housing 1040 to which the bottom end 1056 is coupled. The reflector 1050 has an outer surface (i.e., facing the adjacent side wall 1041 and top wall 1042 of the housing 1040) and an inner surface opposite the outer surface.

The optical device 1030 of the edge-lit light fixture 1000 has a body 1031 and can include a coupling feature 1039 in the form of mating threads disposed along the outer side surface of the body 1031, where the coupling feature 1039 is configured to be removably coupled to a coupling feature 1049 in the form of complementary mating threads disposed in the inner surface at the distal end of the side wall 1041 of the housing 1040. When the optical device 1030 is coupled to the housing 1040, the optical device 1030 closes off the open bottom end of the cavity 1045 formed by the housing 1040. The body 1031 of the optical device 1030 includes a coupling feature 1138 in the form of a recess on its top surface along the outer perimeter of the optical device 1030. The coupling feature 1038, in conjunction with the coupling feature 1048 of the housing 1040 and the coupling feature 1018 (discussed below) of the reflector 1010 to allow the reflector to be directly coupled to the housing 1040 and the optical device 1030. The optical device 1030 also includes one or more optical features (e.g., reflectors, refractors) to manipulate the light emitted by the light sources 1025 as the light travels from the cavity 1045 to a volume of space outside the cavity 1045 to provide general illumination.

The example reflector 1010 of the edge-lit light fixture 1000 is disposed in the cavity 1045 formed by the housing 1040 and the optical device 1030. The reflector 1010 hides the light sources 1025 from view by a user positioned below the edge-lit light fixture 1000. Most of the reflector 1010 lacks a vertical or a horizontal orientation along its true vertical height 1014. The reflector 110 has a convex curvature 1015 along its true vertical height 1014 between its top end 1017 and its bottom end 1016. The various characteristics (e.g., curvature 1015, true vertical height 1014, material, color) of the reflector 1010 can be the same as, or different than, the corresponding characteristics of the reflector 1050.

The example reflector 1010 is positioned toward the bottom of the cavity 1045. The bottom end 1016 of the reflector 1010 includes a coupling feature 1018 in the form of a lateral extension the couples to (fits within) the coupling feature 1048 of the housing and the coupling feature 1038 of the optical device 1030. As a result, the top end 1017 of the reflector 1010 is positioned in the cavity 1045 at a horizontal distance 1092 away from the circuit board 1021. In addition, the top end 1017 of the reflector 1010 is positioned in the cavity 1045 at a vertical distance 1091 below the bottom end of the light sources 1025.

The curvature 1015 of the body 1011 of the reflector 1010 is between the top end 1017 and the bottom end 1016 of the reflector 1010. The curvature 1015 is parabolic. The reflector 1010 has a height 1014 (e.g., a true vertical height) that spans between the top end 1017 and the bottom end 1016 of the reflector 1010. The reflector 1010 forms a closed shape. The bottom end 1016 of the reflector 1010 has a shape and size that corresponds to a perimeter formed by the bottom part of the inner surface of the side wall 1041 of the housing 1040. The reflector 1010 has an outer surface (i.e., facing the adjacent side wall 1041 of the housing 1040) and an inner surface opposite the outer surface. The inner surface and the outer surface of the reflector 1010 are of a color (e.g., bright white) and/or have a material (e.g., glossy acrylic) that is reflective (e.g., highly reflective).

The reflector 1010 and its various characteristics (e.g., curvature 1015 of the body 1011, color, coating, true vertical height 1014), as well as the characteristics (e.g., color, coating) of the inner surfaces of the side wall 1041 and the top wall 1042 of the housing 1040, as well as the characteristics (e.g., curvature 1055, color, coating, true vertical height 1054) of the optional reflector 1050, can redirect light through an optical device at the bottom end of the housing 1040 that is substantially evenly distributed without hot spots or dead spots. In this way, the edge-lit light fixture 1000 can function without a waveguide or lightguide. Further, the reflector 1010 prevents a user from looking into the cavity 1045 through the optical device 1030 from seeing any of the light sources 1025.

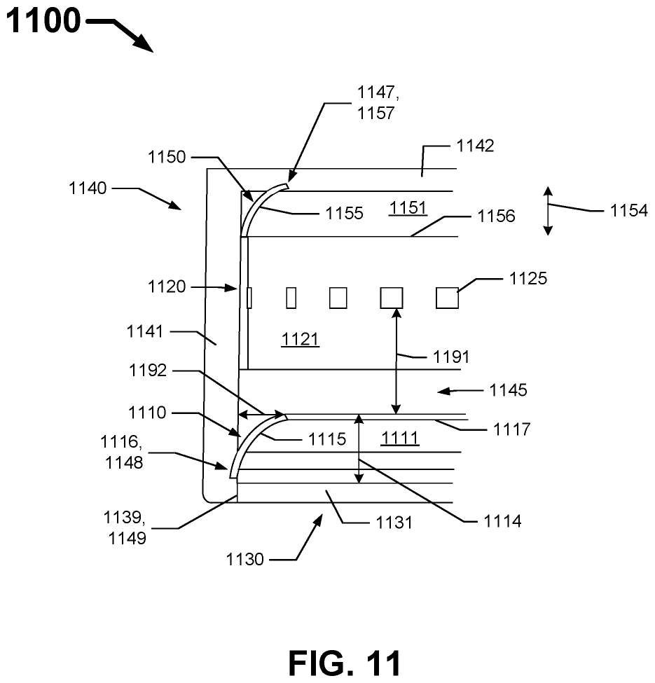

FIG. 11 shows a sectional side view of a portion of yet another edge-lit light fixture 1100 without a waveguide according to certain example embodiments. Referring to FIGS. 1A through 11, the edge-lit light fixture 1100 (including components and/or features thereof) of FIG. 11 is substantially the same as the edge-lit light fixtures (including any corresponding components and/or features) discussed above with respect to FIGS. 1A through 10, except as described below. For example, the edge-lit light fixture 1100 of FIG. 11 includes a housing 1140, an optical device 1130, a circuit board assembly 1120, an example reflector 1110, and another example reflector 1150.

The circuit board assembly 1120 includes a circuit board 1121 and multiple light sources 1125 coupled to the circuit board 1121. The light sources 1125 are directed outward into the cavity 1145. The circuit board assembly 1120 of the edge-lit light fixture 1100 is disposed on (e.g., coupled to) the side wall 1141 of the housing 1140. The housing 1140 of the edge-lit light fixture 1100 is cylindrical, having a top wall 1142 and a side wall 1141 that form the cavity 1145 with an open bottom end. The housing 1140 is made of a thermally conductive material that allows the housing 1140 to act as a heat sink.

Some or all of the inner surface of the side wall 1141 and/or some or all of the inner surface of the top wall 1142 can be or be coated with a reflective (e.g., highly reflective) material (e.g., coated with a glossy acrylic, made of a highly polished light-colored metal). In addition, or in the alternative, some or all of the inner surface of the side wall 1141 and/or some or all of the inner surface of the top wall 1142 can be of a color (e.g., bright white) that is reflective (e.g., highly reflective).

The inner surface of the side wall 1141 at the far bottom of the side wall 1141 includes a coupling feature 1149 in the form of mating threads. The coupling feature 1149 is used to couple the optical device 1130 to the housing 1140. The inner surface of the side wall 1141 also includes a coupling feature 1148 in the form of an inward recess toward the bottom of the side wall 1141. The coupling feature 1148 is located just above the coupling feature 1149. The coupling feature 1148 of the housing 1140 is used to receive and couple to the bottom end 1116 of the reflector 1110, as discussed below. The coupling feature 1148 and the coupling feature 1149 are disposed along the entire perimeter of the side wall 1141.

The top wall 1142 of the housing 1140 can also include a coupling feature 1147 in the form of a recess disposed in the inner surface of the top wall 1142 toward where the top wall 1142 meets the side wall 1141. The coupling feature 1147 forms a full circle in the top wall 1142. The coupling feature 1147 is configured to receive and couple to the top end 1157) of the reflector 1150, which is an independent component of the edge-light light fixture 1100 rather than an integrated part of the housing 1140.

The example reflector 1150 has a top end 1157 and a bottom end 1156. The top end 1157 of the reflector 1150 is coupled to the coupling feature 1148 in the top wall 1142 of the housing 1140 by being inserted into the coupling feature 1148. In such a case, the top end 1157 can be considered a coupling feature, such as the coupling feature 818 discussed above, because the top end 1157 is configured to directly couple to the coupling feature 1147 in the top wall 1142. The bottom end 1156 of the reflector 1150 is coupled to the side wall 1141 of the housing 1140 by being positioned in such a way that the bottom of the bottom end abuts against the top of the circuit board 1121 and the adjacent outer surface of the reflector 1150 abuts against the side wall 1141 of the housing 1140. The reflector 1150 can be or be coated with a reflective (e.g., a highly reflective) material, which can be the same or different than the reflective material of the inner surfaces of the side wall 1141 and/or the top wall 1142 of the housing 1140. In addition, some or all of the reflector 1150 can be of a color (e.g., bright white) that is reflective.

The body 1151 of the reflector 1150 has a curvature 1155 between the top end 1157 and the bottom end 1156 of the reflector 1150. The curvature 1155 is concave and radial (e.g., a circular arc). The reflector 1150 has a height 1154 (e.g., a true vertical height) that spans between the top end 1157 and the bottom end 1156 of the reflector 1150. The reflector 1150 forms a closed shape. In other words, the reflector 1150 is continuous along its length. The bottom end 1156 of the reflector 1150 can have a shape and size that corresponds to a perimeter formed by the part of the inner surface of the side wall 1141 of the housing 1140 to which the bottom end 1156 is coupled. The reflector 1150 has an outer surface (i.e., facing the adjacent side wall 1141 and top wall 1142 of the housing 1140) and an inner surface opposite the outer surface.

The optical device 1130 of the edge-lit light fixture 1100 has a body 1131 and can include a coupling feature 1139 in the form of mating threads along the outer side surface of the body 1131, where the coupling feature 1139 is configured to be removably coupled to a coupling feature 1149 in the form of complementary mating threads disposed in the inner surface at the distal end of the side wall 1141 of the housing 1040. When the optical device 1130 is coupled to the housing 1140, the optical device 1130 closes off the open bottom end of the cavity 1145 formed by the housing 1140. The optical device 1130 also includes one or more optical features (e.g., reflectors, refractors) disposed within the body 1131 to manipulate the light emitted by the light sources 1125 as the light travels from the cavity 1145 to a volume of space outside the cavity 1145 to provide general illumination.

The example reflector 1110 of the edge-lit light fixture 1100 is disposed in the cavity 1145 formed by the housing 1140 and the optical device 1130. The reflector 1110 hides the light sources 1125 from view by a user positioned below the edge-lit light fixture 1100. Most of the reflector 1110 lacks a vertical or a horizontal orientation along its true vertical height 1114. The reflector 1110 has a convex curvature 1115 along its true vertical height 1114 between its top end 1117 and its bottom end 1116. The various characteristics (e.g., curvature 1115 of the body 1111, true vertical height 1114, material, color) of the reflector 1110 can be the same as, or different than, the corresponding characteristics of the reflector 1150.

The example reflector 1110 is positioned toward the bottom of the cavity 1145. The bottom end 1116 of the reflector 1110 is coupled to the side wall 1142 of the housing 1140 when the bottom end 1116 is inserted into the coupling feature 1148 in the side wall 1142. In such a case, the bottom end 1116 can be considered a coupling feature, such as the coupling feature 818 discussed above, because the bottom end 1116 is configured to directly couple to the coupling feature 1148 in the side wall 1142. As a result, the top end 1117 of the reflector 1110 is positioned in the cavity 1145 at a horizontal distance 1192 away from the circuit board 1121. In addition, the top end 1117 of the reflector 1110 is positioned in the cavity 1145 at a vertical distance 1191 below the bottom end of the light sources 1125.

The curvature 1115 of the body 1111 of the reflector 1110 is between the top end 1117 and the bottom end 1116 of the reflector 1110. The curvature 1115 is parabolic. The reflector 1110 has a height 1114 (e.g., a true vertical height) that spans between the top end 1117 and the bottom end 1116 of the reflector 1110. The reflector 1110 forms a closed shape. The bottom end 1116 of the reflector 1110 has a shape and size that corresponds to a perimeter formed by the bottom part of the inner surface of the side wall 1141 of the housing 1140. The reflector 1110 has an outer surface (i.e., facing the adjacent side wall 1141 of the housing 1140) and an inner surface opposite the outer surface. The inner surface and the outer surface of the reflector 1110 are of a color (e.g., bright white) and/or have a material (e.g., glossy acrylic) that is reflective (e.g., highly reflective).

The reflector 1110 and its various characteristics (e.g., curvature 1115, color, coating, true vertical height 1114), as well as the characteristics (e.g., color, coating) of the inner surfaces of the side wall 1141 and the top wall 1142 of the housing 1140, as well as the characteristics (e.g., curvature 1155, color, coating, true vertical height 1154) of the optional reflector 1150, can redirect light through an optical device at the bottom end of the housing 1140 that is substantially evenly distributed without hot spots or dead spots. In this way, the edge-lit light fixture 1100 can function without a waveguide or lightguide. Further, the reflector 1110 prevents a user from looking into the cavity 1145 through the optical device 1130 from seeing any of the light sources 1125.

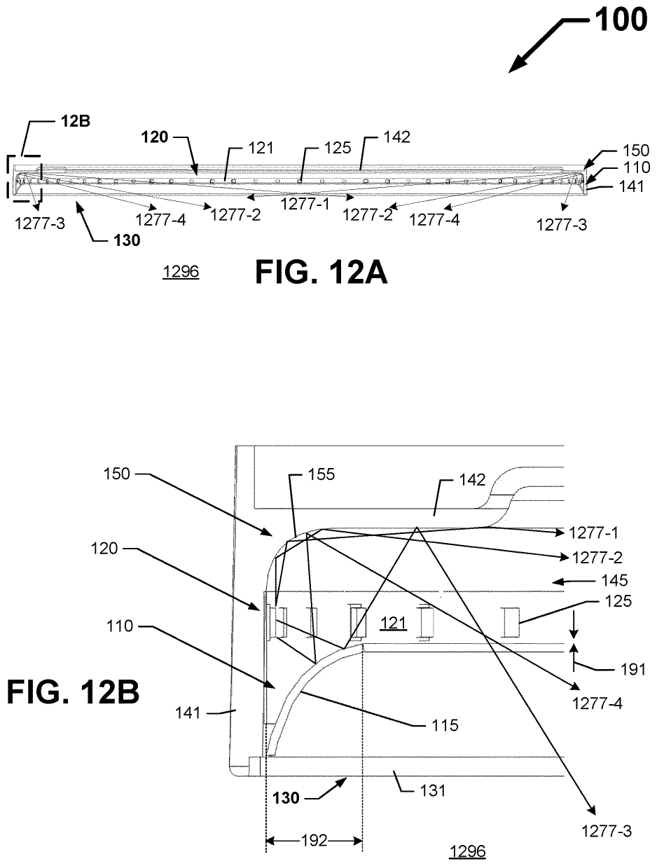

FIGS. 12A and 12B show light distribution patterns 1277 for the edge-lit light fixture 100 of FIGS. 1A through 1E according to certain example embodiments. Specifically, FIG. 12A shows some light distribution patterns 1277 using a sectional view of the edge-lit light fixture 100 of FIGS. 1A through 1E. FIG. 12B shows some light distribution patterns 1277 using a detailed view of FIG. 12A. Referring to FIGS. 1A through 12B, the light fixture 100 includes a reflector 110, a circuit board assembly 120, an optical device 130, and a housing 140 with an integrated reflector 150. The housing 140 has a side wall 141 and a top wall 142 that form a cavity 145. The circuit board assembly 120 includes a circuit board 121 and multiple light sources 125 disposed on the circuit board 121. The reflector 110 has a convex curvature 115 and is positioned proximate to the junction of the optical device 130 and the distal end of the side wall 141 of the housing 140. The top end of the reflector 110 is positioned in the cavity 145 at a horizontal distance 192 away from the circuit board 121.

The reflector 110 of the light fixture 100 can serve one or more of a number of purposes. For example, as discussed above, the reflector 110 can hide the light sources 125 from view of a user in the volume of space 1296 into which the light 1277 emitted by the light sources 125 is directed. Specifically, because of the convex curvature 115 of the reflector, combined with its positioning within the cavity 145 relative to the light sources 125 (e.g., the top of the reflector 110 is positioned the horizontal distance 192 away from the circuit board 121, the top of the reflector 110 is positioned a vertical distance 191 away from the bottom of the light sources 125), the light sources 125 are hidden from view from the volume of space 1296 by the inner surface (i.e., the surface facing the optical device 130) of the reflector 110. In other words, the inner surface of the reflector 110 is configured to provide an obstacle that prevents a line of sight from the volume of space 1296 outside the housing 140 through the optical device 130 to the light sources 125.

This purpose can also have the reverse effect. Specifically, the reflector 110 can prevent the light 1277 emitted by the light sources 125 from being directly emitted through the optical device 130. Instead, due to the position, curvature 115, height, vertical distance 191 from the bottom of the light sources 125, horizontal distance 192 from the circuit board 121, and/or other characteristics of the reflector 110, particularly the outer surface (i.e., the opposite side from the inner surface) of the reflector 110, any of the light 1277 that travels through the body 131 of the optical device 130 to the volume of space 1296 is reflected (e.g., by the outer surface of the reflector 110, by the top wall 142 of the housing 140, by the side wall 141 of the housing 140) at least one time within the cavity 145. As a result, any “hot spots” or “headlight effects” caused by the light fixture 100 and experienced by a user in the volume of space 1296 can be greatly reduced or eliminated.

As another example, the reflector 110 can be used to distribute some of the light 1277 emitted by the light sources 125. For instance, as shown in FIGS. 12A and 12B, the outer surface of the reflector 110 can be made of or coated with a reflective material that redirects the light 1277 that contacts the reflector 110. The configuration (e.g., curvature 115, height, material) of the reflector 110, particularly the outer surface of the reflector 110, can be designed to push the light 1277 within the cavity 145 toward the top wall 142 and/or the side wall 141 of the housing 140 so that the light 1277 travels toward a center of the body 131 of the optical device 130 into the volume of space 1296. The impact of the outer surface of the reflector 110 on the light 1277 emitted by the light sources 125 is shown, in part, by way of example, with light ray 1277-3 and light ray 1277-4 in FIGS. 12A and 12B.

Similarly, the reflector 150, when present (as in this case), can also serve one or more purposes. For example, the reflector 150 can be used to distribute some of the light 1277 emitted by the light sources 125. For instance, as shown in FIGS. 12A and 12B, the inner surface (i.e., the surface exposed to the cavity 145) of the reflector 150 can be made of or coated with a reflective material that redirects the light 1277 that contacts the reflector 150. The configuration (e.g., the convex curvature 155, height, material) of the reflector 150, particularly the inner surface of the reflector 150, can be designed to push the light 1277 within the cavity 145 toward the center of the body 131 of the optical device 130 into the volume of space 1296. The impact of the inner surface of the reflector 150 on the light 1277 emitted by the light sources 125 is shown, at least in part, by way of example, with light ray 1277-2, light ray 1277-3, and light ray 1277-4 in FIGS. 12A and 12B.

These contributions by the reflector 150 and/or the reflector 110 can greatly reduce or eliminate a contrast in illumination (e.g., “hot spots”, “dead spots”) between the perimeter of the light fixture 100 and the center of the light fixture 100. As the size (e.g., diameter) of the light fixture 100 is large enough (e.g., 6 inch diameter or greater), these contributions become more important because the larger sizes make it more difficult to achieve an even illumination appearance. The reflector 110 and/or the reflector 150 can be made of, for example, sheet metal (sometimes called “spinnings”), which can be made using a relatively simple and low-cost process (e.g., when compared to high pressure injection molded plastic). Light ray 1277-1 of FIGS. 12A and 12B does not contact the reflector 110 or the reflector 150. Instead, the highly reflective surface of the top wall 142 of the housing 140 is used to redirect the light 1277 within the cavity 145 toward the center of the body 131 of the optical device 130.

Example embodiments can be used to allow for edge-lit light fixtures without a waveguide or lightguide. Example embodiments hide the light sources (e.g., LEDs) within a cavity of the so that a person looking up into the edge-lit light fixture is unable to see the light sources. Example embodiments can also redirect light through an optical device at the bottom end of the housing that is substantially evenly distributed without “hot spots” or “dead spots”. In some cases, at least part of the example embodiments can be integrated with the housing of the edge-lit light fixture. Example embodiments can be used with edge-lit light fixtures having any of a number of sizes, shapes, and/or features. Example embodiments can be used in new installations of edge-lit light fixtures as well as retrofitting existing edge-lit light fixtures. Example embodiments also provide a number of other benefits. Such other benefits can include, but are not limited to, increased ease of maintenance, greater ease of use, increased reliability, modularity, ease of installation, reduced cost, reduced weight, and compliance with industry standards that apply to linear light fixtures.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive.

From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. An edge-lit light fixture comprising:
a housing having a side wall and a top wall that form a cavity having an open bottom end;
a circuit board assembly disposed on the side wall of the housing, wherein the circuit board comprises a circuit board and a light source coupled to the circuit board, wherein the light source is oriented on the circuit board to direct light into the cavity;
an optical device coupled to a distal end of the side wall of the housing, wherein the optical device closes off the open bottom end of the cavity; and
a reflector disposed in the cavity, wherein the reflector has a convex curvature along a height between a top end and a bottom end, wherein the bottom end of the reflector is positioned proximate to a junction of the optical device and the distal end of the side wall, wherein the top end of the reflector is positioned in the cavity at a horizontal distance away from the circuit board, wherein the reflector has an inner surface and an outer surface, and wherein the inner surface of the reflector is configured to provide an obstacle that prevents a line of sight from outside the housing through the optical device to the light source.

2. The edge-lit light fixture of claim 1, wherein the top end of the reflector is further positioned a vertical distance from the light source.

3. The edge-lit light fixture of claim 1, further comprising:
an additional reflector disposed in the cavity, wherein the additional reflector has a top end and a bottom end wherein the top end of the additional reflector abuts against the top wall of the housing, and wherein the bottom end of the reflector abuts against the circuit board and is positioned above the light source.

4. The edge-lit light fixture of claim 1, further comprising:
an additional reflector disposed in the cavity wherein the additional reflector has a top end and a bottom end wherein the top end of the additional reflector abuts against the top wall of the housing, and wherein the bottom end of the additional reflector abuts against the side wall and is positioned above the light source.

5. The edge-lit light fixture of claim 4, wherein the side wall of the housing has a receiving feature disposed therein for receiving the bottom end of the additional reflector.

6. The edge-lit light fixture of claim 4, wherein the top wall of the housing has an additional receiving feature disposed therein for receiving the top end of the additional reflector.

7. The edge-lit light fixture of claim 4, wherein the additional reflector has the convex curvature along its height between the top end of the additional reflector and the bottom end of the additional reflector.

8. The edge-lit light fixture of claim 7, wherein the convex curvature is parabolic with a focus that substantially coincides with a center of the optical device.

9. The edge-lit light fixture of claim 7, wherein the height of the additional reflector and the height of the reflector are substantially identical.

10. The edge-lit light fixture of claim 4, wherein the additional reflector is integrated with the side wall and the top wall of the housing.

11. The edge-lit light fixture of claim 1, wherein the reflector is continuous along its length to form a closed shape that corresponds to a perimeter formed by the side wall of the housing.

12. The edge-lit light fixture of claim 1, wherein the side wall and the top wall of the housing have inner surfaces that are reflective.

13. The edge-lit light fixture of claim 1, wherein the side wall of the housing has a first coupling feature that complements a second coupling feature along the bottom end of the reflector, and wherein the first coupling feature and the second coupling feature, when engaged with each other, secure the reflector relative to the circuit board.

14. The edge-lit light fixture of claim 1, wherein the optical device has a first coupling feature along its outer surface that complements a second coupling feature along the bottom end of the reflector, and wherein the first coupling feature and the second coupling feature, when engaged with each other, secure the reflector relative to the optical device.
